(19) United States
(12) Patent Application Publication
(10) Pub. No.: US 2014/0198036 A1
(43) Pub. Date: Jul. 17, 2014

(54) METHOD FOR CONTROLLING A PORTABLE APPARATUS INCLUDING A FLEXIBLE DISPLAY AND THE PORTABLE APPARATUS

(71) Applicant: Samsung Electronics Co., Ltd., Gyeonggi-do (KR)

(72) Inventors: Yeonjung KIM, Gyeonggi-do (KR); Yoonjeong Choi, Seoul (KR)

(73) Assignee: Samsung Electronics Co., Ltd., Gyeonggi-do (KR)

(21) Appl. No.: 14/155,935

(22) Filed: Jan. 15, 2014

(30) Foreign Application Priority Data
Jan. 15, 2013 (KR) 10-2013-0004323

(51) Int. Cl. G06F 3/0487; G06F 3/03; G06F 3/0481; G06F 1/16

(52) U.S. Cl. CPC G06F 3/0487; G06F 1/1652; G06F 3/03; G06F 3/04817
USPC 345/156

(57) ABSTRACT

An apparatus and method for controlling a portable apparatus including a flexible display are provided. The method includes detecting a bent portion of the flexible display; displaying a User Interface (UI) on the detected bent portion of the flexible display; detecting an input through the UI displayed on the detected bent portion of the display; and performing an operation corresponding to the input detected through the UI displayed on the detected bent portion of the display.

### PRIORITY

This application claims priority under 35 U.S.C. §119(a) to Korean Patent Application Serial No. 10-2013-0004323, which was filed in the Korean Intellectual Property Office on Jan. 15, 2013, the entire disclosure of which is incorporated herein by reference.

### BACKGROUND OF THE INVENTION

1. Field of the Invention

The present disclosure relates generally to a method for controlling a portable apparatus including a flexible display and the portable apparatus, and more particularly, to an apparatus and method for controlling the portable apparatus including the flexible display through a User Interface (UI) presented in a bent portion of the flexible display.

2. Description of the Related Art

A flexible display is a new development that allows an entire portable apparatus to fold or bend a screen thereof, thereby improving portability of the portable apparatus.

The flexible display, as the name implies, is flexible, and as such, can bend. However, an example of a device actively using the flexibility of the flexible display is extremely rare. Particularly, general technology of controlling a portable apparatus using a touch screen method applied to a front surface or a rear surface of the flexible display has been discussed, but an input and output method of the flexible display has not been considered.

### SUMMARY OF THE INVENTION

Accordingly, the present invention is designed to address at least the problems and/or disadvantages described above and to provide at least the advantages described below.

An aspect of the present invention is to provide a method and apparatus for controlling a portable apparatus including a flexible display, based on a user input occurring in a bent portion of a flexible display.

Another aspect of the present invention is to provide a method and apparatus for controlling a portable apparatus including a flexible display using a UI of a bent portion of the flexible display.

In accordance with an aspect of the present invention, a method is provided for controlling a portable apparatus including a flexible display. The method includes detecting a bent portion of the flexible display; displaying a User Interface (UI) on the detected bent portion of the flexible display; detecting an input through the UI displayed on the detected bent portion of the display; and performing an operation corresponding to the input detected through the UI displayed on the detected bent portion of the display.

In accordance with another aspect of the present invention, a portable apparatus is provided, which includes a flexible display; and a controller that detects a bent portion of the flexible display, displays a User Interface (UI) on the detected bent portion of the flexible display, detects an input through the UI displayed on the detected bent portion of the display; and controls the portable apparatus to perform an operation corresponding to the input detected through the UI displayed on the detected bent portion of the display.

In accordance with another aspect of the present invention, a method is provided for controlling a portable apparatus including a flexible display. The method includes detecting a bent portion of the flexible display; comparing a curvature of the bent portion to a threshold curvature; and if the curvature of the flexible display is less than the threshold curvature, displaying a User Interface (UI) on the detected bent portion of the flexible display, detecting an input through the UI displayed on the detected bent portion of the display, and performing an operation corresponding to the input detected through the UI displayed on the detected bent portion of the display.

In accordance with another aspect of the present invention, a portable apparatus is provided, which includes a flexible display; and a controller that detects a bent portion of the flexible display, compares a curvature of the bent portion to a threshold curvature, and if the curvature of the flexible display is less than the threshold curvature, displays a User Interface (UI) on the detected bent portion of the flexible display, detects an input through the UI displayed on the detected bent portion of the display, and controls the portable apparatus to perform an operation corresponding to the input detected through the UI displayed on the detected bent portion of the display.

### BRIEF DESCRIPTION OF THE DRAWINGS

The above and other aspects, features, and advantages of certain embodiments of the present disclosure will be more apparent from the following detailed description in conjunction with the accompanying drawings, in which:

FIG. 1 is a block diagram illustrating a portable apparatus including a flexible display according to an embodiment of the present invention;

FIG. 2 is a perspective view illustrating a portable apparatus including a flexible display being bent according to an embodiment of the present invention;

FIGS. 3A to 3C illustrate various bending examples of a portable apparatus including a flexible display according to an embodiment of the present invention;

FIG. 4 is a flowchart illustrating a method for controlling a portable apparatus including a flexible display according to an embodiment of the present invention;

FIG. 5 illustrates an example of a UI formed in a bent portion of a portable apparatus including a flexible display according to an embodiment of the present invention;

FIG. 6 illustrates an example of a UI formed in a bent portion of a portable apparatus including a flexible display according to an embodiment of the present invention;

FIG. 7 illustrates an example of a UI formed in a bent portion of a portable apparatus including a flexible display according to an embodiment of the present invention;

FIG. 8 illustrates an example of an input occurring in a bent portion of a portable apparatus including a flexible display according to an embodiment of the present invention;

FIG. 9 illustrates an example of an input occurring in a bent portion of a portable apparatus including a flexible display according to an embodiment of the present invention; and

FIG. 10 illustrates an example of a method of controlling a portable apparatus including a flexible display according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

As indicated above, various embodiments of the present invention are directed to controlling a portable apparatus including a flexible display. Herein, examples of a portable apparatus including a flexible display include, but are not limited to, to display apparatus including a flexible display as well as general electronic terminals such as smart phones, portable terminals, mobile terminals, Personal Digital Assistant (PDAs), Portable Multimedia Player (PMPs), notepads, Wibro terminals, tablet Personal Computers (PCs), etc.

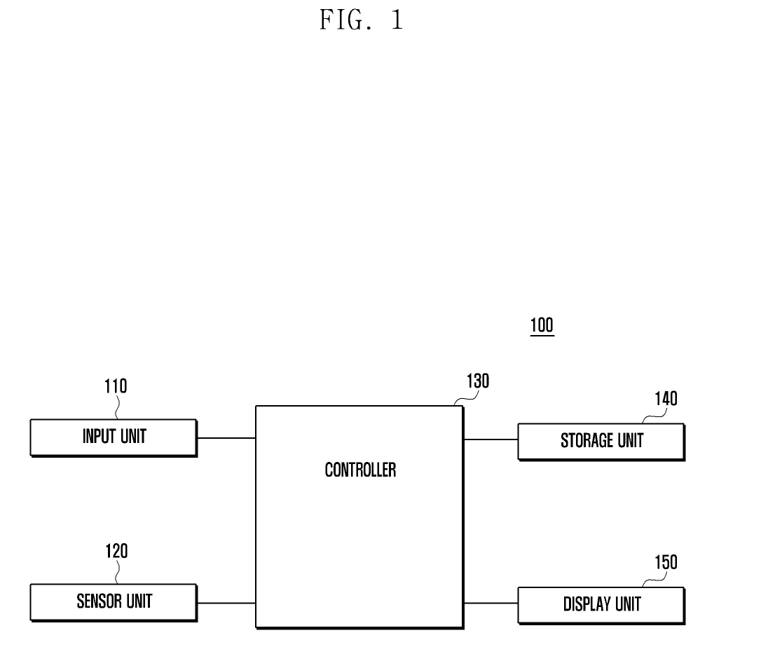

FIG. 1 is a block diagram illustrating a portable apparatus including a flexible display according to an embodiment of the present invention.

Referring to FIG. 1, a portable apparatus 100 includes an input unit 110, sensor unit 120, controller 130, e.g., a microprocessor, storage unit 140, e.g., a memory device, and display unit 150, i.e., a flexible display.

The input unit 110 detects a user input and outputs an input signal corresponding to the user input to the controller 130. For example, the input unit 110 may include a key pad, dome switch, touch pad (capacitive/resistive), jog wheel, jog switch, finger mouse, wheel, etc.

The input unit 110 may be formed with an input pad or may be formed by mounting various sensors of the sensor unit 120, as will be described later. The input unit 110 may be formed using a touch sensor that is attached in a film form on an input pad or may be formed in an input pad coupled in a panel form.

Alternatively, the input unit 110 may be formed with an input pad utilizing an ElectroMagnetic Resonance (EMR) or ElectroMagnetic Interference (EMI) method using an electromagnetic sensor. In order to detect an input using a plurality of sensors, the input unit 110 may be formed with at least one input pad forming an interlayer structure.

The input unit 110 may operate as an input screen by forming a layer structure with the display unit 150, as will be described later. For example, the input unit 110 may include an input pad having a touch sensor and may include a Touch Screen Panel (TSP) coupled to the display unit 150. Herein, the input unit 110 forming a layer structure with the display unit 150 may be referred to as a touch screen.

According to an embodiment of the present invention, a touch screen is formed with a flexible display. Therefore, the input unit 110 detects inputs occurring in the flexible display. When the input unit 110 is coupled to various sensors, such as a touch sensor or an electromagnetic sensor, the input unit 110 may detect a touch input, proximity input, and hovering input occurring in the flexible display. Particularly, when the input unit 110 operates as a touch screen by coupling to a flexible display, the input unit 110 may detect an input occurring on the flexible display operating as a touch screen.

The sensor unit 120 may be formed with a plurality of sensors to detect a current state of the portable apparatus 100. The sensor unit 120 generates a control signal corresponding to a detected state and outputs the control signal to the controller 130. For example, the sensor unit 120 may include a touch sensor, proximity sensor, and electromagnetic sensor.

The touch sensor detects a user touch input. For example, the touch sensor may include a touch film, a touch sheet, and a touch pad. The touch sensor detects a touch input and outputs the detected touch signal to the controller 130.

The controller 130 performs operation corresponding to a touch signal by analyzing a touch signal.

Further, information corresponding to the detected touch signal may be displayed in the display unit 150.

The touch sensor may also receive an input through various input objects. For example, the touch sensor may receive an input by a user's body part body (e.g., hand) or a physical device, such as a stylus pen. Additionally, a manipulation button may be included in the stylus pen.

The touch sensor may also detect a proximity input within a constant distance as well as a direct touch input according to an implementation method.

The touch sensor may be formed in a touch pad form by coupling to the input unit 110 and then detecting the user's touch input through the input unit 110.

The proximity sensor detects whether an object is positioned within a predetermined distance of a surface of the input unit 110, and may also detect access, movement, direction, speed, and form of the object using a force of an electromagnetic field, without actual contact. For example, the proximity sensor may include at least one of a transmissive photoelectric sensor, a direct reflective photoelectric sensor, a mirror reflective photoelectric sensor, a high frequency oscillation type proximity sensor, a capacitive proximity sensor, a magnetic proximity sensor, and an infrared ray proximity sensor.

The electromagnetic sensor detects a touch or proximity input according to an intensity change of an electromagnetic field and may be formed in an input pad form of an EMR or EMI method. For example, the electromagnetic sensor may include a coil that induces a magnetic field and detects access of an object including a resonant circuit that causes an energy change of a magnetic field that has occurred in the electromagnetic sensor. The electromagnetic sensor is an object including a resonant circuit and may detect an input by a stylus pen.

Further, the sensor unit 120 may includes at least one of a motion sensor, a pressure sensor, a temperature sensor, a tension sensor, a current sensor, a haptic sensor, or a slope sensor, and when the display unit 150 is embodied as a flexible display, the sensor unit 120 may detect whether the flexible display is bent, and a bent portion may be detected.

The controller 130 controls constituent elements for general operations of the portable apparatus 100. For example, when the display unit 150 of the portable apparatus 100 includes a flexible display, the controller 130 controls operation of the portable apparatus 100 based on an input through the flexible display.

According to an embodiment of the present invention, the controller 130 controls the portable apparatus 100 according to an input detected in a bent portion of the display unit 150 including a flexible display. For example, the controller 130 may perform at least one of reproduction control, display control, camera photographing control, application control, or lock control of the portable apparatus 100.

Further, according to an embodiment of the present invention, the controller 130 controls the display unit 150 to display a UI in a bent portion to correspond to the bending of the display unit 150.

The storage unit 140 stores programs or commands for the portable apparatus 100. The controller 130 performs a program or a command stored at the storage unit 140.

For example, the storage unit 140 includes at least one of a flash memory, a hard disk, a micro multimedia card, a card type memory (e.g., Secure Digital (SD) or eXtreme Digital (XD) memory), a Random Access Memory (RAM), a Static Random Access Memory (SRAM), a Read-Only Memory (ROM), an Electrically Erasable Programmable Read-Only Memory (EEPROM), a Programmable ROM (PROM), a magnetic memory, a magnetic disk, or an optical disk.

According to an embodiment of the present invention, the storage unit 140 stores information about control operations corresponding to a user input. Further, the storage unit 140 stores a threshold curvature to be a reference in which the controller 130 determines that the display unit 150 is bent. A curvature may be determined when manufacturing the portable apparatus 100 or may be determined according to a user selection. For example, a curvature may be set to at least two values in order to distinguish a bent level of the display unit 150.

The display unit 150 displays (outputs) information processed in the portable apparatus 100. For example, the display unit 150 displays information corresponding to a presently driven application, program, or service together with a UI or a graphic UI (GUI).

In accordance with an embodiment of the present invention, the display unit 150 includes a flexible display. The flexible display can bend because it is constructed using a plastic substrate instead of a glass substrate. A bent state and a bent portion of the flexible display may be detected by coupling the flexible display to the sensor unit 120 or using an internally mounted sensor. Additionally, a plurality of flexible displays may be disposed at a front surface and/or a rear surface of the portable apparatus 100.

The display unit 150 may operate as a touch screen by forming an interlayer structure with the input unit 110 and the sensor unit 120. In this case, the display unit 150 operating as a touch screen may perform a function of an input device.

According to an embodiment of the present invention, the display unit 150 may display a UI in a bent portion according to the control of the controller 130. For example, the UI may be formed with at least one icon, image, text, symbol, etc.

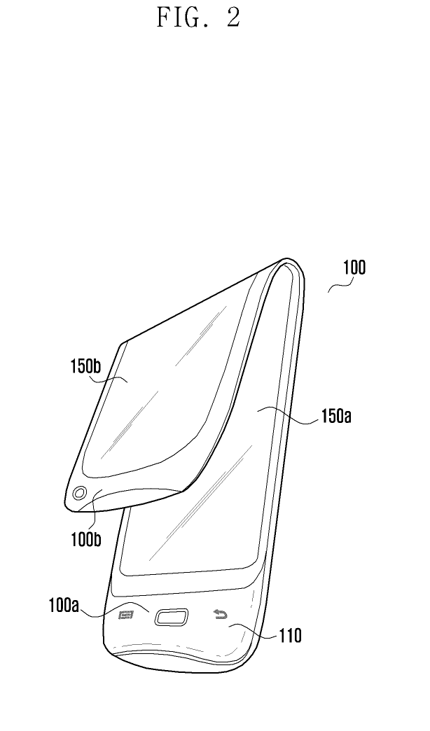

FIG. 2 illustrates a perspective view of a portable apparatus including a flexible display according to an embodiment of the present invention.

Referring to FIG. 2 the portable apparatus 100 is formed with a front case 100a and a rear case 100b. Constituent elements are housed at internal space formed within the front case 100a and the rear case 100b. Additionally, at least one intermediate case may be disposed between the front case 100a and the rear case 100b.

A first display unit 150a is disposed at the front case 100a. Further, a camera, a sound output unit, e.g., a speaker, a microphone, and the input unit 110 may also be disposed at the front case 100a. A second display unit 150b is disposed at the rear case 100b. Additionally, a camera, a sound output unit, a microphone, or the input unit 110 may be disposed at the rear case 100b.

The first display unit 150a and the second display unit 150b visually present information. Further, as a touch pad is overlapped in a layer structure, the first display unit 150a and the second display unit 150b may operate as a touch screen.

The first display unit 150a and the second display unit 150b each include a flexible display that may be bent.

When an area of the flexible display has a curvature greater than a preset threshold curvature, the controller 130 determines that a detected area is bent through a corresponding curvature. Herein, a preset threshold curvature is a preset value to determine whether the user has intentionally bent a flexible display. When an area of a flexible display is bent with a curvature smaller than a threshold curvature, the controller 130 may determine that the flexible display is not bent.

The first display unit 150a and the second display unit 150b may have various forms according to a curvature of a bent portion. By comparing a magnitude of a detected curvature with that of a threshold curvature, controller 130 may also determine a bending level and a bending form of a flexible display.

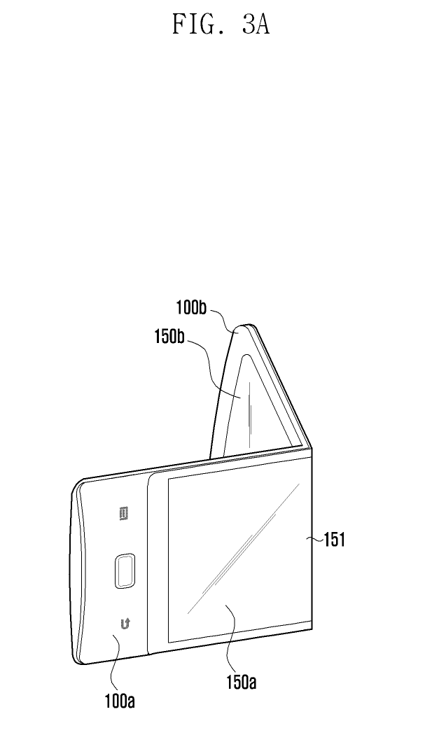

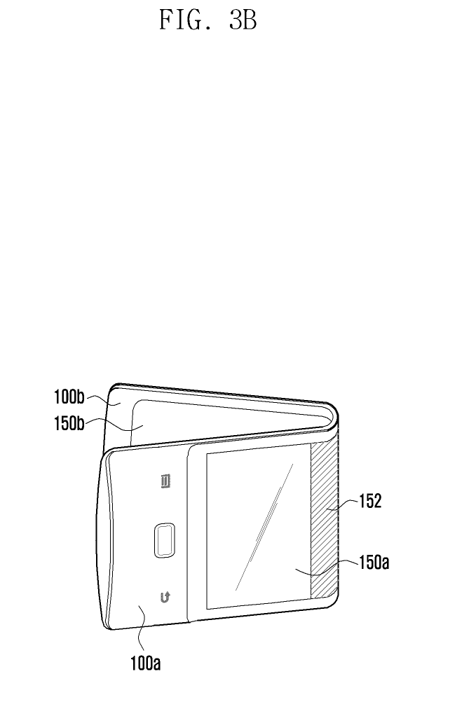

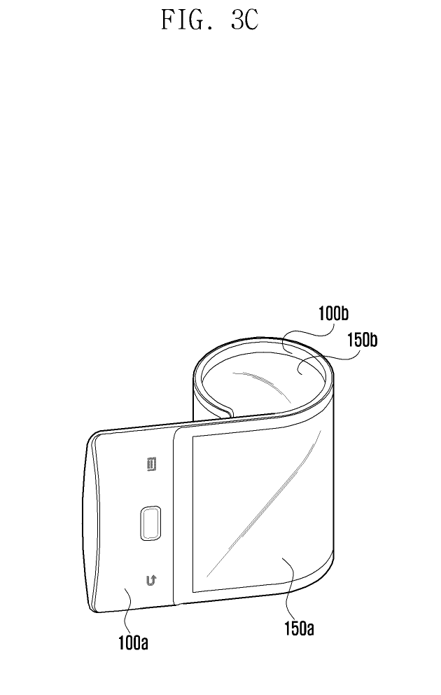

FIGS. 3A to 3C illustrate various bending examples of a portable apparatus including a flexible display according to an embodiment of the present invention.

Referring to FIG. 3A, the first display unit 150a and the second display unit 150b bend to form a sharp curved surface. A bent portion 151 has a large curvature and may form a complete corner or a narrow surface. The bent state illustrated in FIG. 3A may also be referred to as a folded state.

When manufacturing a flexible display or according to the user's selection, the controller 130 may previously set a second threshold curvature to determine whether the flexible display is in a folded state. As illustrated in FIG. 3A, when the bent portion 151 of the flexible display is greater than or equal to a preset second threshold curvature, the controller 130 determines that the first display unit 150a and the second display unit 150b are in a folded state.

Referring to FIG. 3B, the first display unit 150a and the second display unit 150b bend to form a smooth curved surface, compared to the example illustrated in FIG. 3A, wherein the bend has a cornered edge. In FIG. 3B, a bent portion 152 has a relatively small curvature and may form a wider surface than the bent portion 151 illustrated in FIG. 3A.

When manufacturing a flexible display, or according to the user's selection, the controller 130 may previously set a first threshold curvature to determine whether the flexible display is in a slowly bent state. In this case, the first threshold curvature may be set to a value smaller than the second threshold curvature.

As illustrated in FIG. 3B, when the bent portion 152 of the flexible display is greater than or equal to a preset first threshold curvature and is smaller than the second threshold curvature, the controller 130 determines that the first display unit 150a and the second display unit 150b are in a curved bend. When the first display unit 150a and the second display unit 150b are continually bent, the first display unit 150a and the second display unit 150b may form a roll, as illustrated in FIG. 3C.

For example, when the flexible display is bent, the second display unit 150b may be exposed at a front surface of the portable apparatus 100, as illustrated in FIG. 2. However, when the flexible display is bent in a direction opposite to a direction illustrated in FIG. 2, the first display unit 150a is exposed at a front surface of the portable apparatus 100.

As illustrated in FIG. 2, the second display unit 150b exposed to a front surface of the portable apparatus 100 is referred to as a first area, and the second display unit 150b positioned at a rear surface of the portable apparatus 100 is referred to as second area. In accordance with an embodiment of the present invention, the controller 130 may control the second display unit 150b to display different information in the first area and the second area, respectively. Similarly, the controller 130 may control the first display unit 150a to display different information than the second display unit 150b, when a portion of the first display unit 150a is also exposed at a rear surface or a front surface.

The input unit 110 formed in the front case 100a may be embodied with a dome switch or a touch pad that may receive an input of a command or information by the user's push or touch manipulation, or may be embodied as a wheel, jog method, or jog stick that rotates a key. From a function viewpoint, the input unit 110 may also operate as a hot key to activate an input of a command such as start, end, and scroll, or a special function within the portable apparatus 100.

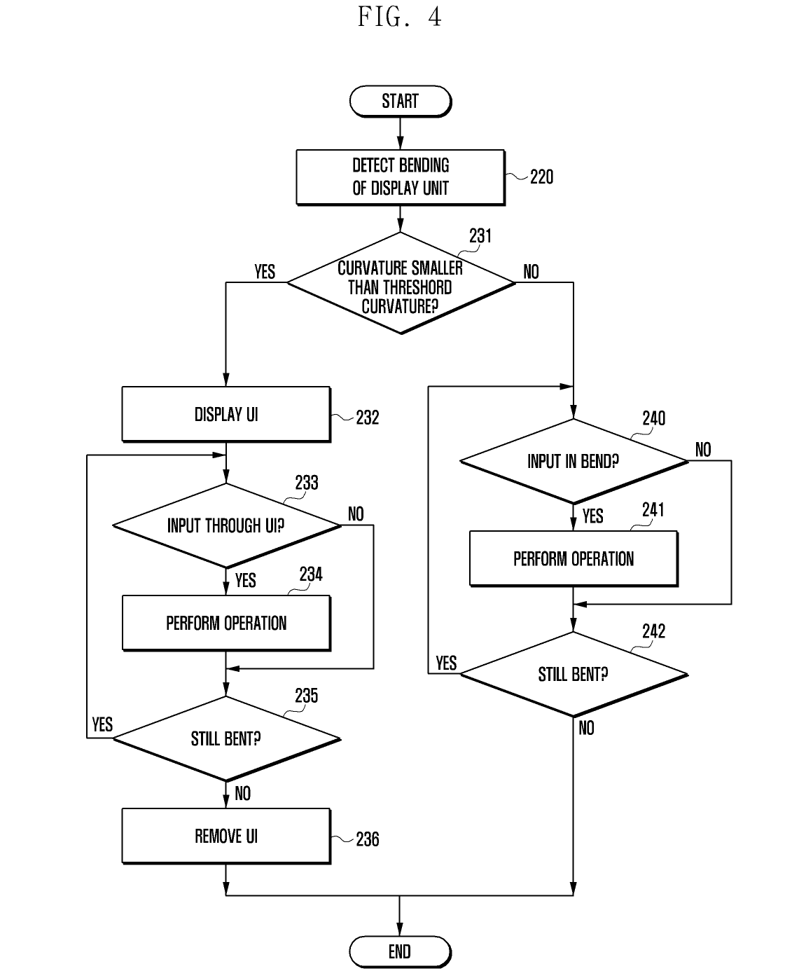

FIG. 4 is a flowchart illustrating a method for controlling a portable apparatus including a flexible display according to an embodiment of the present invention.

Although the method illustrated in FIG. 4 is described using an example in which the display unit 150 is bent, the method is not limited thereto and can be applied to different manipulations of the flexible display, such as the display unit 150 being rolled, a corner of the display unit 150 being flipped, the display unit 150 being squeezed, etc.

Referring to FIG. 4, the display unit 150 including a flexible display normally in a flat state, i.e., not bent.

In step 220, the controller 130 detects the bending of the display unit 150.

As described above, the controller 130 may detect bending of the display unit 150 according to a control signal output from a sensor mounted in the inside of the display unit 150 or the sensor unit 120 provided in the portable apparatus 100. Further, the controller 130 may determine whether the display unit 150 is bent based on curvature information of the display unit 150 included in the control signal.

Specifically, the controller 130 may be preset with a first threshold curvature, e.g., by a user or during manufacturing, to determine whether the display unit 150 is bent. For example, the first threshold curvature may be stored in the storage unit 140.

When the control signal indicates a curvature greater than the first threshold curvature is detected in an area of the display unit 150, the controller 130 detects that a corresponding area is bent in step 220.

For example, when the first threshold curvature is previously set, and a curvature of an area of the display unit 150 is smaller than the first threshold curvature, the controller 130 determines that the corresponding area of the display unit 150 is in a normal state, i.e., a non-bent state. Further, if the display unit 150 is in the normal state, the controller 130 controls the portable apparatus 100 according to conventional methods.

However, when the curvature of the area of the display unit 150 is greater than or equal to the first threshold curvature, the controller 130 detects a bend in the corresponding area of the display unit 150. In this case, the controller 130 may determine a position of a bent portion based on the control signal. For example, the controller 130 may extract a coordinate of the bent portion and determine a position of the bent portion on the display unit 150.

When bending is repeatedly detected over the entire display unit 150, the controller 130 may determine that the display unit 150 is rolled. Further, the controller 130 may detect various states of the display unit 150 according to a position and a curvature of a bent portion of the display unit 150.

In step 231, after detecting a bend in the display unit 150, the controller determines if the bend is smaller than a second threshold curvature, which is greater than the first threshold curvature. That is, the controller 130 may determine whether the bent portion forms a smooth curved surface.

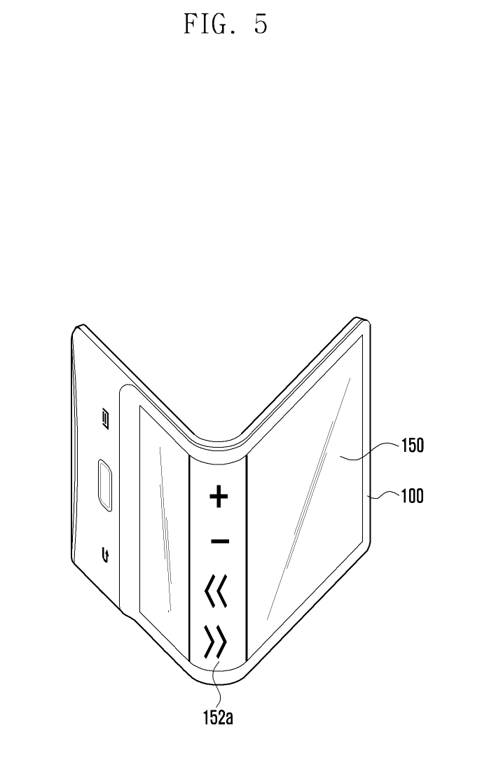

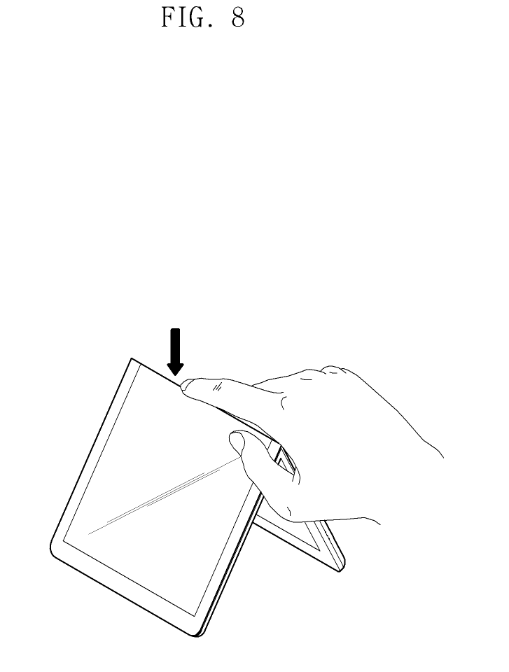

Specifically, the controller 130 is preset with the second threshold curvature, e.g., by a user or during manufacturing, to distinguish whether the bent portion of the display unit 150 forms a sharp curved surface (i.e., a folded state) or a smooth curved surface. For example, the second threshold curvature is stored in the storage unit 140. The second threshold curvature may be greater than the first threshold curvature. If a curvature of the bent portion is greater than the second threshold curvature, the controller 130 determines that a corresponding area forms a sharp curved surface, e.g., as illustrated in FIG. 8. However, if a curvature of the bent portion is smaller than the second threshold curvature, the controller 130 determines that the corresponding area forms a smooth curved surface, e.g., as illustrated in FIG. 5.

If a curvature of the bend is smaller than the second threshold curvature in step 231, the controller 130 displays a UI in the bent portion in step 232. For example, the UI may be formed with at least one icon, image, text, symbol, etc. Basically, when the curvature of the bent portion is smaller than the second threshold curvature, the bent portion is considered large enough to display a UI therein, which can be easily seen and interacted with by a user. However, when the display unit 150 is sharply bent, i.e., when a curvature of the bent portion greater than the second threshold curvature, the bent portion may form a corner or a very narrow surface. In this case, it may be inefficient to display a UI in the bent portion

In accordance with an embodiment of the present invention, the controller 130 displays a UI corresponding to a presently driven application.

For example, when a presently driven application is a music or video player application, the controller 130 may control the display unit 150 to display a UI 152a for reproduction control, as illustrated in FIG. 5. In FIG. 5, the UI 152a includes an interface option for volume adjustment, reproduction of a previous file/next file, and reproduction of a previous channel/next channel, although various other controls may be included therein.

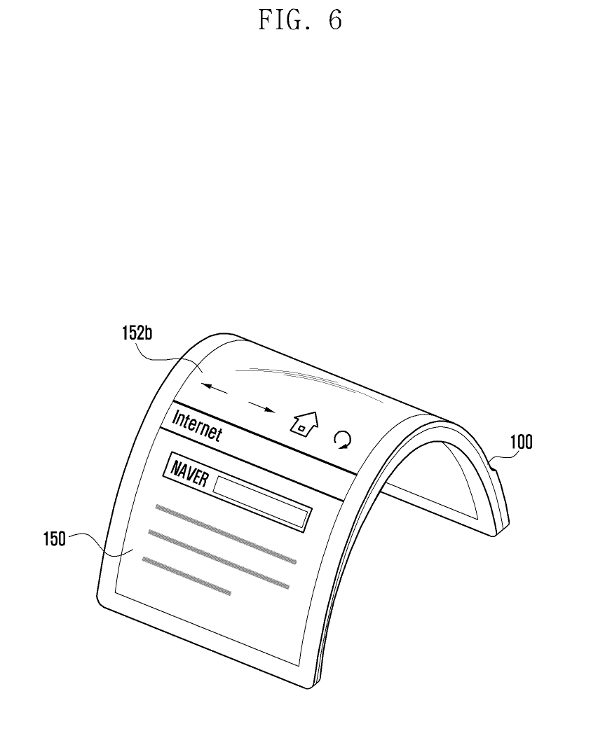

Alternatively, when the presently driven application is an application for displaying content, e.g., a web page, an e-book, a picture, a memo, etc., the controller 130 may control the display unit 150 to display a UI 152b for display control, as illustrated in FIG. 6. In FIG. 6, the presently driven application is an application to view a Web page, and the controller 130 controls the display unit 150 to display the UI 152b including controls for a previous screen/next screen, home screen display, and refresh, although various other web controls may be included therein.

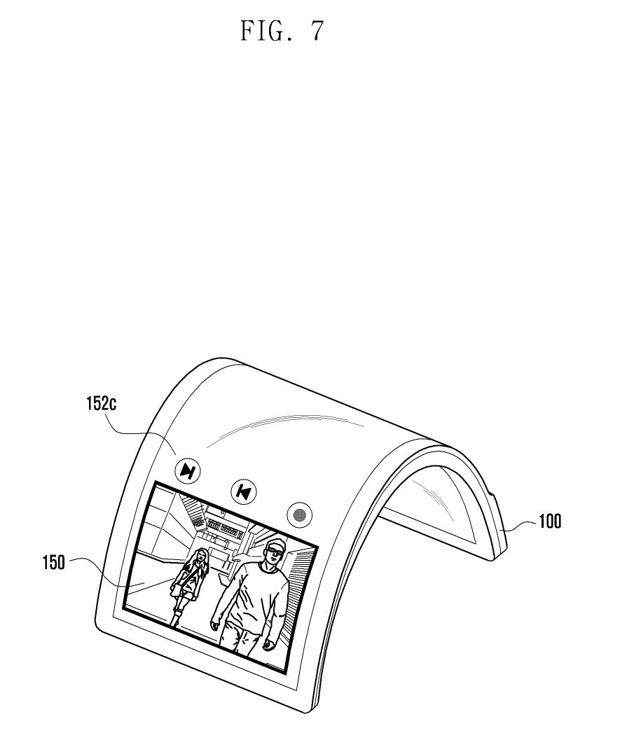

As another example, when the presently driven application is a camera application, the controller 130 may control the display unit 150 to display a UI 152c for photographing control, as illustrated in FIG. 7. In FIG. 7, the UI 152c includes controls for moving to previous and next videos and recordings, although various other camera controls may be included therein.

In the foregoing description, several UIs corresponding to bending of the display unit 150 are exemplified, but the present disclosure is not limited thereto and various UIs may be displayed based on a curvature of the display unit 150, the presently driven application, and a movement state of the portable apparatus 100.

In step 233, the controller 130 determines if an input is detected through the UI displayed in the bent portion. The controller 130 may determine whether a user input is detected through a control signal generated in the display unit 150 embodied as a touch screen. The controller 130 may determine a position at which an input is detected, type of input, and input attribute according to the type of input based on a control signal.

As described above, an input may be made by a human body part, e.g., a finger, or an object, such as a stylus, and may occur by a touch, a proximity sensing, and/or hovering of an object to the display unit 150. Further, an input may be formed with push, drag, and flick. The controller 130 may determine an input type and an input attribute according to the input type, based on the control signal. The input attribute may include a moving direction, a moving distance, a moving speed, a pressing intensity, etc., according to an input type.

If an input is detected through the UI displayed in the bent portion in step 233, then the controller 130 controls the portable apparatus 100 according to the command selected from UI in step 234.

If an input is not detected through the UI displayed in the bent portion in step 233 or after the controller 130 controls the portable apparatus 100 according to the command selected from UI in step 234, then the controller 130 determines if the display unit 150 is still bent in step 235.

The controller 130 may determine whether the display unit 150 is still bent according to a control signal output from a sensor mounted at the inside of the display unit 150 or the sensor unit 120 provided in the portable apparatus 100. The controller 130 may determine whether bending of the display unit 150 is released based on curvature information of the display unit 150 included in a control signal.

For example, if a curvature is still greater than or equal to the first curvature threshold, the controller 130 may determine that the display unit 150 is still in a bent state. However, if a curvature is smaller than the first curvature threshold, the controller 130 may determine that bending of the display unit 150 is released.

If the display unit 150 is still bent in step 235, the controller 130 continues to display the UI and determines if an input is detected through the UI displayed in the bent portion in step 233 again. If the display unit 150 is not bent in step 235, the controller 130 the controller 130 removes the UI corresponding to bending from the display unit 150 in step 236.

However, referring back to step 231, if the controller determines that the bend is not smaller than the second threshold curvature in step 231, i.e., when a curvature of the bent portion greater than the second threshold curvature, the controller identifies that the display unit 150 is sharply bent.

As described above, because the bent portion forms a corner or a very narrow surface in this case, it is inefficient to display a UI in the bent portion. However, while it may be inefficient to display a UI in the bent portion, special inputs may still be received through the bent portion.

Accordingly, in step 240, the controller 130 determines whether an input is entered in the bent portion. As described above, the controller 130 may determine whether an input has occurred at a certain position on the display unit 150 based on a control signal, and thus, may determine whether an input has occurred in a bent portion of the display unit 150.

As the display unit 150 is bent, the controller 130 may preset a threshold range of the display unit 150 to define a bent portion. For example, when a bent position forms a corner, the controller 130 may define the corner as a bent portion, or may define a range within a constant distance from a portion having a largest curvature to a bent portion.

If an input is detected in a bent portion in step 240, the controller 130 performs an operation corresponding to the input entered in the bent portion in step 241.

For example, an input may be a push or tap gesture on the bent portion, as illustrated in FIG. 8.

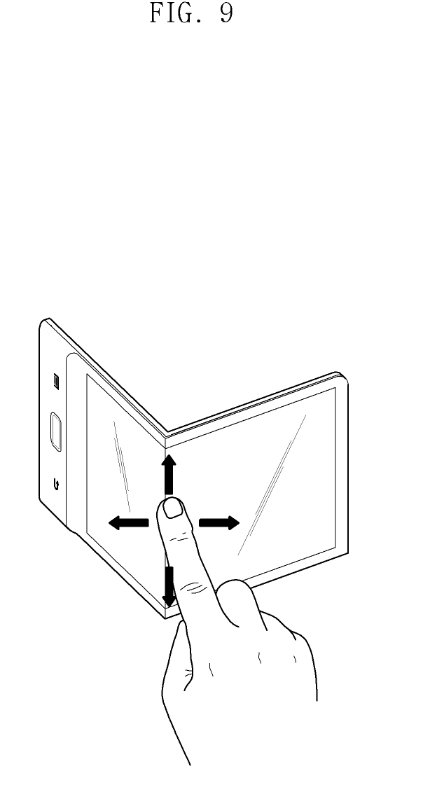

Alternatively, an input may be a drag operation on or from the bent portion, as illustrated in FIG. 9. In this case, a drag may vertically move along a corner or operation that laterally flicks from the corner within the folded position 151.

The controller 130 may determine an input position, input kind, and input attribute of an input that has occurred in a bent portion. The controller 130 may determine an accurate position in which an input has occurred within a bent portion based on an input signal.

In step 241, the controller 130 performs a control operation corresponding to the determined input. For example, the controller 130 may perform reproduction control, display control, photographing control, application control, or lock control of the portable apparatus 100 to correspond to the determined input.

If an input occurs at a different position other than a bent portion on the display unit 150, the controller 130 performs a control operation of the portable apparatus 100 according to a general touch input.

Similar to the steps performed when displaying the UI, the controller 130 may perform operations corresponding to an input, based on a presently driven application.

For example, when the presently driven application is a music or video player application, the controller 130 may perform operation of reproduction, stopping, volume adjustment, navigating to a previous file/next file, previous channel/next channel reproduction, etc., corresponding to an input detected in a bent portion.

Table 1 illustrates several operation examples when a vertical/lateral drag input, as illustrated in FIG. 9, is detected in a bent portion of the display unit 150.

TABLE 1

| Application | Vertical drag input | Lateral drag input |
|---|---|---|
| Music reproduction | Volume up/down | Previous song/next song |
| application | | |
| Moving picture | Volume up/down | Previous moving |
| reproduction application | | picture/next moving |
| | | picture |
| Web page viewer (Internet | Page scroll | Previous page/next page |
| application) | | |
| E-book application | Text size up/down | Previous page/next page |
| Memo application | Page scroll | Previous page/next page |
| List viewer | List scroll | File viewing, upper level |
| | | list/lower level list |
| Camera application | Zoom in/zoom out | Front camera/rear |
| | | camera |

| | |
|---|---|
| Lock control | Lock release |

In the foregoing description, different operations of the controller 130 for several different applications are described by way of example. However, the present invention is not limited to these described examples and the controller 130 may perform various other operations according to various other functions, applications, programs, and services provided in the portable apparatus 100.

If an input does not occur in a bent portion in step 240 or after the controller 130 performs a control operation corresponding to the determined input in step 241, the controller 130 determines if the display unit 150 is still bent in step 242.

For example, when a curvature is greater than or equal to the second curvature threshold, the controller 130 may determine that the display unit 150 is still bent. However, if a curvature is smaller than the first curvature threshold, the controller 130 may determine that bending of the display unit 150 is released.

If the display unit 150 is still bent in step 242, the operation returns to step 240 to determine if an input is detected in the bent portion again. However, if the display unit 150 is not bent in step 242, the procedure ends.

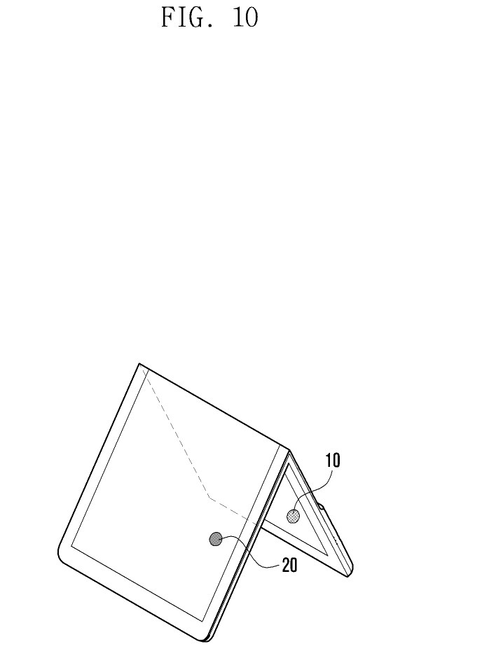

Specifically, as illustrated in FIG. 2, when the display unit 150 is bent, one area of the display unit 150 may be exposed at a front surface and other areas may be exposed at a rear surface. An area exposed at the front surface and a rear surface may be the first display unit 150a or the second display unit 150b according to a bending direction of the display unit 150. In this case, inputs 10 and 20 may occur in other areas instead of a bent portion, for example, in the display unit 150 exposed at a rear surface, as shown in FIG. 10.

According to the foregoing embodiment, when a user grips a flexible display with both hands and folds the display unit 150 over, a front surface UI may be easily manipulated with four fingers that normally grip a rear surface, and thus, user convenience can be provided.

As described above, a method and apparatus are provided for controlling a portable apparatus including a flexible display, wherein, when bending and using the flexible display, a UI may be presented via a bent portion or special input may be input via the bent portion, providing a more convenient device to the user.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for controlling a portable apparatus including a flexible display, the method comprising:
detecting a bent portion of the flexible display;
displaying a User Interface (UI) on the detected bent portion of the flexible display;
detecting an input through the UI displayed on the detected bent portion of the display; and
performing an operation corresponding to the input detected through the UI displayed on the detected bent portion of the display.

2. The method of claim 1, wherein detecting the bent portion of the flexible display comprises:
determining a curvature of the flexible display;
comparing the determined curvature to a preset threshold curvature; and
determining that the flexible display is bent, if the determined curvature is greater than or equal to the preset threshold curvature.

3. The method of claim 1, wherein displaying the UI on the detected bent portion of the flexible display comprises displaying at least one icon of the UI at the bent portion.

4. The method of claim 3, wherein displaying the at least one icon comprises:
identifying an application currently being driven in the portable apparatus;
identifying the at least one icon corresponding to the identified application; and
displaying the at least one icon.

5. The method of claim 1, further comprising:
detecting a release of the bent portion of the flexible display; and
removing the UI from the flexible display according to the release.

6. A portable apparatus, comprising:
a flexible display; and
a controller configured to detect a bent portion of the flexible display, display a User Interface (UI) on the detected bent portion of the flexible display, detect an input through the UI displayed on the detected bent portion of the display, and control the portable apparatus to perform an operation corresponding to the input detected through the UI displayed on the detected bent portion of the display.

7. The portable apparatus of claim 6, wherein the controller detects the bent portion of the flexible display by determining a curvature of the flexible display, comparing the determined curvature to a preset threshold curvature, and determining that the flexible display is bent, if the determined curvature is greater than or equal to the preset threshold curvature.

8. The portable apparatus of claim 6, wherein the controller displays the UI on the detected bent portion of the flexible display by displaying at least one icon of the UI at the bent portion.

9. The portable apparatus of claim 8, wherein the controller displays the at least one icon by identifying an application currently being driven in the portable apparatus, identifying the at least one icon corresponding to the identified application, and displaying the at least one icon.

10. The portable apparatus of claim 6, wherein the controller detects a release of the bent portion of the flexible display, and removes the UI from the flexible display according to the release.

11. A method for controlling a portable apparatus including a flexible display, the method comprising:
detecting a bent portion of the flexible display;
comparing a curvature of the bent portion to a threshold curvature; and
if the curvature of the flexible display is less than the threshold curvature, displaying a User Interface (UI) on the detected bent portion of the flexible display, detecting an input through the UI displayed on the detected bent portion of the display, and performing an operation corresponding to the input detected through the UI displayed on the detected bent portion of the display.

12. The method of claim 11, further comprising:
if the curvature of the flexible display is not less than the threshold curvature, detecting an input through bent portion of the display, and performing an operation corresponding to the input detected through the bent portion of the display.

13. The method of claim 11, wherein displaying the UI on the detected bent portion of the flexible display comprises displaying at least one icon of the UI at the bent portion.

14. The method of claim 13, wherein displaying the at least one icon comprises:
identifying an application currently being driven in the portable apparatus;
identifying the at least one icon corresponding to the identified application; and
displaying the at least one icon.

15. The method of claim 13, further comprising:
detecting a release of the bent portion of the flexible display; and
removing the UI from the flexible display according to the release.

16. A portable apparatus, comprising:
a flexible display; and
a controller configured to detect a bent portion of the flexible display, compare a curvature of the bent portion to a threshold curvature, and if the curvature of the flexible display is less than the threshold curvature, display a User Interface (UI) on the detected bent portion of the flexible display, detect an input through the UI displayed on the detected bent portion of the display, and control the portable apparatus to perform an operation corresponding to the input detected through the UI displayed on the detected bent portion of the display.

17. The portable apparatus of claim 16, wherein if the curvature of the flexible display is not less than the threshold curvature, the controller detects an input through bent portion of the display, and performs an operation corresponding to the input detected through the bent portion of the display.

18. The portable apparatus of claim 16, wherein the controller displays the UI on the detected bent portion of the flexible display by displaying at least one icon of the UI at the bent portion.

19. The portable apparatus of claim 18, wherein the controller displays the at least one icon by identifying an application currently being driven in the portable apparatus, identifying the at least one icon corresponding to the identified application, and displaying the at least one icon.

20. The portable apparatus of claim 16, wherein the controller detects a release of the bent portion of the flexible display, and removes the UI from the flexible display according to the release.
